(19) United States
(12) Patent Application Publication
(10) Pub. No.: US 2008/0114799 A1
(43) Pub. Date: May 15, 2008

(54) System and Method for Utilizing XML Documents to Transfer Programmatic Requests in a Service Oriented Architecture

(75) Inventor: Harris J. Chasen, Clermont, FL (US)

Correspondence Address: WILDMAN HARROLD ALLEN & DIXON LLP, 225 WEST WACKER DRIVE, SUITE 2800, CHICAGO, IL, 60606, US

(73) Assignee: F4W, INC., Lake Mary, FL (US)

(21) Appl. No.: 11/938,861

(22) Filed: Nov. 13, 2007

Related U.S. Application Data
(60) Provisional application No. 60/865,727, filed on Nov. 14, 2006.

(51) Int. Cl. G06F 7/00

(52) U.S. Cl. 707/101; 707/E17.127

(57) ABSTRACT

A system and method for communicating extensible markup language (XML) documents in a service oriented architecture (SOA) are provided. XML requests are made in the form of XML documents containing programmatic requests. An XML schema defines programmatic behavior and provides instructions on how to process an XML document having a programmatic request. An application component receives an XML document with at least one programmatic request to perform a service. A generic XML request is sent to a broker that accesses a registry storing namespace information. The broker converts the generic XML request to a specific XML service request based on instruction information received from the registry. The specific XML service request (in the form of an XML document having at least one programmatic request) is translated and sent to a services component to service the request.

### CROSS-REFERENCE TO RELATED APPLICATION

This application claims priority from U.S. Provisional Application No. 60/865,727 filed on Nov. 14, 2006.

### FIELD OF INVENTION

The present invention relates to computer software systems and more particularly to systems employing service oriented architecture (SOA) using extensible markup language (XML).

### BACKGROUND OF THE INVENTION

Conventional software applications in the past have been modified by re-writing sections of code, re-compiling, and re-linking the code to create a new application. This can be a time consuming process when creating new software applications to meet different customer needs.

Service oriented architecture (SOA) is a relatively new software-based architecture that is not tied to a specific technology. SOA defines the use of software services to support the requirements of system processes. In an SOA environment, resources on a network are made available as independent services that can be accessed without knowledge of their underlying platform implementation. SOA based systems may be independent of particular development technologies and platforms such as user developed Java and .Net.

Part of creating an SOA application is the use of extensible markup language (XML). XML provides a mechanism for communicating with hierarchical self-describing data and syntax. XML documents are used for transmitting complex data structures and generally contain information such as data elements, tags, mechanisms to define the tags, and user definitions of the tags. XML information is manifested as text interspersed with syntax that indicates the separation of information into a hierarchy of character data, elements, descriptions, and attributes of those elements. The names, hierarchy and meanings of elements and attributes are definable by a customizable schema. The syntax of such XML-based languages is rigid. XML documents must adhere to XML-based rules to assure that XML parsers will understand the arrangement of information within them. These syntax rules are supplemented with a set of constraints. Additionally, schemas often restrict element and attribute names and their allowable containment hierarchies. Constraints in a schema may also include data type assignments that affect how information is processed. There is a need to improve upon existing XML-based communication of information to program and support a wide variety of software behavior in SOA environments.

### SUMMARY

A system and method for communicating XML documents in a service oriented architecture environment are provided. XML requests are made through the employment of XML documents having at least one programmatic request that are sent and received between software-based components of the system. A programmatic request may be a request that provides instructions or directions for a software program to complete. An XML schema defines programmatic behavior and provides instructions on how to process XML documents containing programmatic requests.

A user interface of the computer software-based system sends an XML request, as an XML document having at least one programmatic request, to an application component. The application component processes the request and builds a generic XML request that is sent to a broker. The broker accesses a registry storing namespace information. The broker obtains instructions stored in the registry based on the namespace information and the generic XML request (XML document containing a programmatic request) received. The broker converts the generic XML request to a specific XML service request. The specific XML service request may be sent from the broker to a selected translator for translation in order for the request to meet the requirements of the service that services the XML request. Software-based components of the system (such as the application, broker, registry, translators, and services components) may reside in a computer-controlled device or be in a distributed environment residing on multiple computer-controlled devices.

### BRIEF DESCRIPTION OF THE DRAWINGS

FIG. 1 is a system diagram illustrating an example framework of a computer software-based system having service oriented architecture.

FIG. 2 is a flow chart illustrating the process flow of the system of FIG. 1.

### DETAILED DESCRIPTION

A computer implemented system and method for communicating XML documents in a service oriented architecture environment are provided. An application component receives an XML request as an XML document having at least one programmatic request. The application component builds a generic XML request in response to receipt of the XML document having at least one programmatic request. A broker adapted to receive the generic XML request from the application component accesses a registry storing namespace information. The broker converts the generic XML request to a specific XML service request. A translator receives the specific XML service request from the broker and translates the specific XML service request to meet requirements of a service that services the XML request. The broker obtains instructions stored in the registry based on the namespace information and the generic XML request received. The broker converts the generic XML request to the specific XML service request based on the instructions retrieved from the registry.

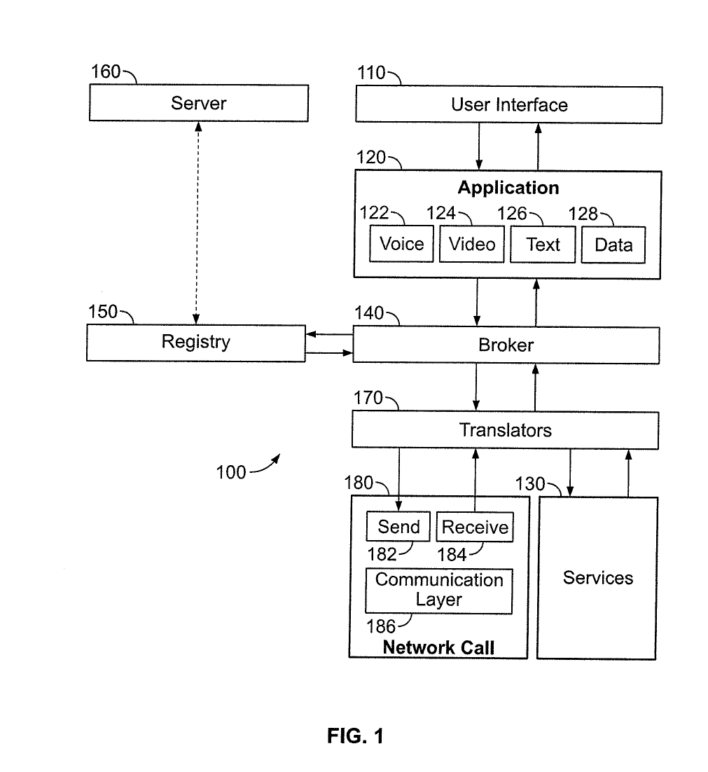

Referring to FIG. 1, system 100 as shown illustrates an example SOA framework that utilizes XML documents to communicate between various components of the system. In the example seen in FIG. 1, user interface 110 provides user interaction with underlying application 120. User interface 110 may, for example, be a graphical user interface (GUI) of computer software-based system 100. Application component 120 may include various sub-applications, for instance sub-applications relating to processing of voice 122, video 124, text 126, data 128 and the like. Application component 120 processes requests from user interface 110 and builds a generic request for support from an appropriate service 130. The selected service 130 processes a request from the application component 120 to perform an activity. Services 130 may come in various forms. For instance, example services may include: .NET encryption; wireless encryption protocol (WEP); Wi-Fi protected access (WPA); remote authentication dial-in user service (RADIUS); file transfer protocol; file transfer using secure shell (SSH); or any other service to perform a requested activity.

The software-based components of system 100 communicate by the sending and receiving of XML documents. As seen in the example in FIG. 1, the software-based components of system 100 may include user interface 110, application component 120, services 130, broker 140, translators 170, and network call 180. Registry 150 provides storage of various data types including namespace information that is accessed by broker 140. In an alternative example, updated namespace information may periodically be received from server 160 that is in communication with registry 150. The framework provided for communication of XML documents, such as in the example of system 100, is an adaptation of service oriented architecture, modified for use in implementing groups of individual, loosely coupled configurable software-based components or applications. For example, software-based components of system 100 (e.g. user interface 110, application component 120, services 130, broker 140, registry 150, translators 170, network call 180) may reside on a single computer controlled device such as a personal computer, laptop computer personal data assistant (PDA), or any other computer controlled device. Additionally, the software-based components of system 100 may also be utilized in a distributed environment in which the software-based components may reside on more than one computing device.

System 100, having service oriented architecture, uses XML documents to transfer programmatic requests between the software-based components. The XML documents used for communication between the components of system 100 have programmatic requests. A programmatic request may be a request that issues instructions or directions for a software program to complete. Thus, in addition to data elements and tags as provided in typical XML documents, programmatic requests are contained in XML documents transmitted between the components of system 100. XML requests (such as a request from user interface to an application to perform a task) may be sent as XML documents containing programmatic requests. An application 120 that calls on a service 130 to perform a task may, for example, transmit an XML document with a programmatic request in addition to data information. An XML request, in the form of an XML document, is sent by the appropriate application component 120 to broker 140 that accesses registry 150. Registry 150 may identify a particular translator 170 to translate an XML document having a programmatic request. The appropriate service 130 may then service the XML request.

To provide communication of XML documents (having programmatic requests) among the components of system 100, an XML schema is followed. The XML schema employed in system 100 defines the programmatic behavior of the different components of the framework, instead of just defining data. The XML schema provides instructions on how to process XML documents containing programmatic requests. The XML schema, because it defines programmatic requests (as well as data) comprises a language grammar. Registry 150 permits control of access rights for changes and a mechanism for extension to the grammar.

As seen in FIG. 1, application component 120 is coupled for communication with broker 140. Broker 140 is a free standing application that brokers transactions between the other software-based components of system 100 by determining what system components are available to perform a request, where the system components reside, and how the system components are invoked. Broker 140 prioritizes a request received as an XML document, substitutes commands and data as requested and passes the request to an appropriate translator 170. The software-based translator component 170 includes various translators for interpreting various pieces of information. Translator 170 translates an XML request (in the form of an XML document) received from the broker 140 into the appropriate format needed by a requested service 130. A generic XML request may be a request that is not specific to the form or method required for completion of the request. For example, the generic request “send file” makes no reference as to how or with what other procedure, behavior or software the request is to be processed. A specific XML service request may be a request that provides for the specific list of procedures, behavior or software a request will use to complete the request. For example, the “send file” generic request (above) may translate to call encryption using the private key of the system, then use file transfer protocol (FTP) to send the file with an anonymous parameter set.

Registry 150 stores information of any type. Information stored in registry 150 may relate to: a user making a request; specifics of an application; a computer device providing a service to be initiated; and permissions held by a user. In particular, namespace information is stored at registry 150. Namespace information may be permanently stored at registry 150, or alternatively, the registry may be coupled to a server 160 for periodically receiving updated namespace information from the server. A namespace is a collection of names, identified by a Uniform Resource Identifier (URI) reference, that are used in XML documents as element types and attribute names. In order for XML documents to be able to use elements and attributes that have the same name but come from difference sources, differentiation between markup elements that come from different sources is needed. System 100 utilizes namespaces to provide different applications 120 with the ability to have the same requests processed in different ways. Additionally, users or applications may desire to prevent other applications from processing data in the same way. Registry 150 provides a mechanism for uniqueness of definition for application specific XML calls, based on modifications needed for a user or a group of users.

When broker 140 uses registry 150, the broker may perform the following operations: determine the application component 120 that has made a request; examine the namespace at registry 150 to see if a specific collection of information is defined for the application; search entries in the namespace for an entry that matches or does not match the request; compare user permissions to access requirements in an entry; perform instructions in the registry 150 which produces a new request form; verify the priority, type of service and quality of service parameters stored in registry 150 or provided by the application component 120 to determine the viability of starting a service 130 and the appropriateness of starting the service immediately; check other services within an operating system; and attempt to start a translator 170 with the request.

As seen in FIG. 1, translators 170 are coupled for communication with broker 140. As described herein, broker 140 passes a specific XML service request (as an XML document) to translators 170 and an appropriate translator translates the XML information to meet the needs of the requested service 130 to process a request. Broker 140 may also track the progress of the specific XML service request in the system. Network call component 180 provides operating system specific calls for connection from an application 120 to an external network, such as the Internet. Network call component 180 may be used to access services that may reside on an outside network. The details of a call to connect are dependent on the operating system implementation. A translator 170 may be provided that changes an XML request defined in the schema as a SEND 182 or RECEIVE 184 request to a specific form and actions required by an operating system to send or receive the information. Network component 180 may include communication layer 186 to enhance quality of service based on different service requirements. Quality of service requests may be generated based on type of service, access control rules (ACL), and requests of a user. For example, requests a user may selectively issue for quality of service may include priority of a service, guaranteed bandwidth, or maximum delay.

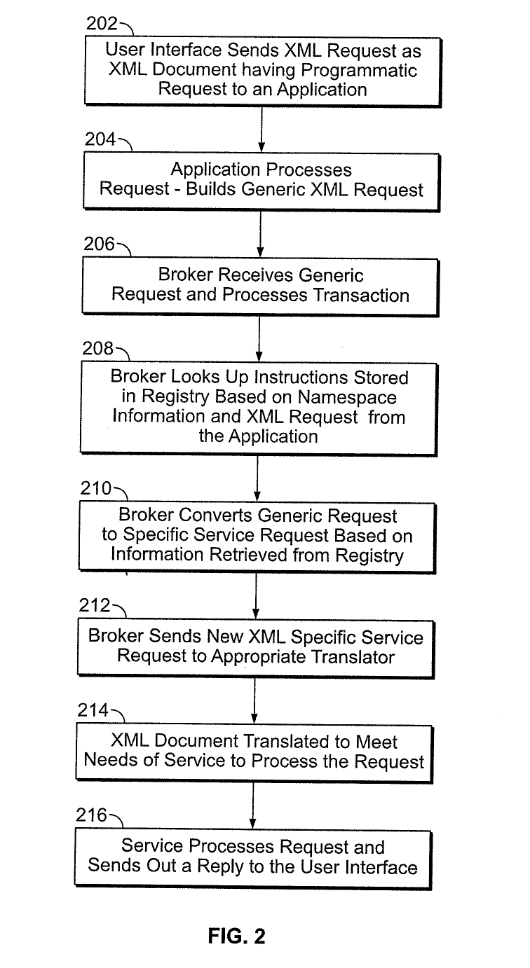

Referring to FIG. 2, the operation of processing user requests utilizing XML documents in computer software-based system 100 having an SOA framework is shown. In step 202, user interface 110 passes an XML request to underlying application component 120. The XML request may be any type of a request, such as activation of a button or link or any other user action request through a user interface. The XML request is an XML document having one or more programmatic requests. The XML document may be a collection of XML tags that can be processed as a stand-alone group by various industry standard XML tools, such as XML editors or Microsoft Internet Explorer. Application component 120 then, in step 204, processes the XML request (in the form of an XML document) from user interface 110, and, as needed, builds a generic XML request for support from one or more services 130. The generic XML request is in the form of an XML document having a programmatic request. In step 206, the generic XML request is sent by the selected application component 120 to the broker 140 which processes the transaction.

In step 208, broker 140 looks up instructions stored in registry 150 based on namespace information and the particular XML document (having a programmatic request) received from the application 120. The broker 140 then, in step 210, converts the generic XML request into a specific XML service request or requests, based on the instructions retrieved from the registry 150 that is specific to the computer processing the request. In step 212, the broker 140 sends the new specific XML service request (also in the format of an XML document with a programmatic request) to the translators 170. The broker 140 also tracks the progress of the specific XML service request in the system. In step 214, the appropriate translator 170 translates the XML document received from the broker (providing a specific service request) to meet the needs of the service 130 to process the request. In step 216, the appropriate service 130 processes the specific XML service request (as an XML document having a programmatic request) and sends a reply back to the user interface 110.

An authentication process may also be provided. Users may be authenticated on startup of system 100 by logging in with a user name and password. In the system 100, namespaces may be assigned to a collection of components of an application or applications 120 developed for a user. The namespace data, for example that is stored at namespace server 160, may be accessible only by users that have a valid key for that namespace. Only users that are provided proper access may use appropriate applications. For example, users who are licensed by a customer can use the applications developed for that customer. Namespace data may, for example, be loaded from a USB (Universal Serial Bus) drive or accessed directly from a web site. The software based components of system 100 and their installation may further be loadable from a USB drive.

As stated, XML documents are sent and received between various software-based components in system 100. The individual components of the system 100 may, for example, reside in computer-controlled devices. In alternative examples, the software-based components may also be distributed across multiple computer-controlled devices. In this example, a simple object access protocol (SOAP) header may be added to the XML request. The XML request having the SOAP header may be sent to a predefined IP address through a request manager. In this distributed application example, support for computer-based devices with limited computing resources (e.g. cell phones, dedicated use computing devices, etc.) may be provided. Additionally, wide area network (WAN) communication may also be provided using a relay implementation. A relay may pass XML requests to registered systems connected over the wide area network through a virtual private network (VPN).

The XML schema creates a mapping between programmatic requests and software code that processes the requests. By being declarative in nature, the XML schema allows application developers to decouple presentation and processing concerns by providing a common platform upon which applications of various types can be built. A number of interfaces may be used as part of the XML schema. For example, a multimedia interface may be employed which requests a multimedia session be initiated. After a response is received, both sides of a transmission will know the format of a multimedia stream and have the information necessary to begin a transmission. An audio-visual service interface operates with the multimedia interface to open a multimedia session.

A public message interface may be used to request that a public message be initiated, transmitted and received. A translator termination interface may be used to facilitate a clean translator termination. A termination message will be sent at exit time for the broker 140, and is initiated by the broker itself, with no response being generated. A chat service interface may be used to request that a chat session be opened, used and terminated. A panic alert interface may be used to send public and private alert messages to users. A user manager interface may be provided to allow for the management of all user functions (e.g. add, remove, change password).

A service description interface may be used that works with the service registry 150. The service registry captures information the broker 140 needs to know about the translators 170 and services 130 available within system 100 and the various XML tags that correspond to them. For each translator or service, information is provided for how the translator is to be invoked and what the physical transport mechanism is for messages within each service description are and information particular to the tags it recognizes.

As provided herein, programmatic requests, as well as data, are passed through the XML document. Instead of containing just data, the XML document passes programmatic requests. The programmatic requests determine the order and type of processing performed by the services 130. The XML schema, because it defines programmatic requests (as well as data) may provide a language grammar. The service oriented architecture provided, such as seen in system 100 in the example of FIG. 1, may selectively use small applications 120 and services 130, and the activation of an application determines the decision to run a service. The broker 140 is not required to be configured by a user; rather namespace equivalence data (i.e. what is in the namespace, substituting one piece of data for another) is loaded into registry 150 and the broker 140 brokers the transaction. The use of XML documents containing programmatic requests provides a number of efficiencies. A framework is provided in which functionality can be added or changed incrementally with minimal effort. The transmission and receipt of XML documents with programmatic requests within an SOA framework allows software developers to develop program applications in less time and creates more efficient programming code.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A computer implemented method for communicating extensible markup language (XML) documents in a service oriented architecture (SOA) environment comprising:
sending an XML request as an XML document having at least one programmatic request;
building a generic XML request in response to receipt of the XML document having at least one programmatic request;
sending the generic XML request to a broker wherein the broker accesses a registry storing namespace information;
converting the generic XML request to a specific XML service request;
sending the specific XML service request to a translator; and
translating the specific XML service request to meet requirements of a service that services the XML request.

2. The computer implemented method of claim 1 wherein the broker obtains instructions stored in the registry based on the namespace information and the generic XML request received.

3. The computer implemented method of claim 2 wherein the broker converts the generic XML request to the specific XML service request based on the instructions retrieved from the registry.

4. The computer implemented method of claim 3 further comprising receiving updated namespace information at the registry from a server in communication with the registry.

5. The computer implemented method of claim 2 wherein the programmatic request is a request that issues instructions for a software program to complete.

6. The computer implemented method of claim 2 wherein an application component processes the XML request and builds the generic XML request in response to receipt of the XML request from a user interface.

7. The computer implemented method of claim 6 wherein the service processes the specific XML service request and sends a reply to the user interface.

8. The computer implemented method of claim 7 wherein the programmatic request determines an order and type of processing performed by the service.

9. The computer implemented method of claim 2 further comprising providing a simple object access protocol (SOAP) header as part of the XML request and communicating the XML request in a distributed environment.

10. The computer implemented method of claim 2 further comprising providing a network call component to access services residing on an external network.

11. The computer implemented method of claim 2 further comprising utilizing a relay implementation to pass XML requests to systems connected over a wide area network through a virtual private network.

12. The computer implemented method of claim 2 further comprising providing an authentication process wherein the namespace information is accessible only by users having a valid key for the namespace.

13. A computer implemented system for communicating extensible markup language (XML) documents in a service oriented architecture (SOA) environment comprising:
an application component that receives an XML request as an XML document having at least one programmatic request, the application component builds a generic XML request in response to receipt of the XML document having at least one programmatic request;
a broker adapted to receive the generic XML request from the application component, the broker accesses a registry storing namespace information, the broker converts the generic XML request to a specific XML service request; and
a translator adapted to receive the specific XML service request from the broker, the translator translates the specific XML service request to meet requirements of a service that services the XML request.

14. The computer implemented system of claim 13 wherein the broker obtains instructions stored in the registry based on the namespace information and the generic XML request received.

15. The computer implemented system of claim 14 wherein the broker converts the generic XML request to the specific XML service request based on the instructions from the registry.

16. The computer implemented system of claim 15 wherein the broker tracks the progress of the specific XML service request.

17. The computer implemented system of claim 15 further comprising a server in communication with the registry wherein the registry receives updated namespace information from the server.

18. The computer implemented system of claim 14 wherein the programmatic request is a request that issues instructions for a software program to complete.

19. The computer implemented system of claim 18 wherein the generic XML request is in the form of an XML document having at least one programmatic request.

20. The computer implemented system of claim 14 wherein the application component processes the XML request and builds the generic XML request in response to receipt of the XML request from a user interface; and
wherein the service processes the specific XML service request and sends a reply to the user interface.

21. The computer implemented system of claim 20 wherein the programmatic request determines an order and type of processing performed by the service.

22. The computer implemented system of claim 20 wherein the application component further comprises voice, video, data and text sub-applications.

23. The computer implemented system of claim 14 wherein said system resides in a distributed environment whereby at least two of said application component, broker, translator, and services are distributed across a plurality of computer-controlled devices.
